(19) United States
(12) Patent Application Publication
(10) Pub. No.: US 2009/0316168 A1
(43) Pub. Date: Dec. 24, 2009

(54) Image processing apparatus, image processing method, and image processing program

(75) Inventor: Takayuki Enjuji, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/456,605

(22) Filed: Jun. 19, 2009

(30) Foreign Application Priority Data
Jun. 20, 2008 (JP) 2008-161389`

(51) Int. Cl. H04N 1/60; G06K 9/00

(52) U.S. Cl. 358/1.9; 382/167

(57) ABSTRACT

An image processing apparatus includes a specific image detection unit detecting an area including at least a part of a specific image in an input image, a state determination unit determining the state of the input image, a color gamut change unit changing a prescribed color gamut in a predetermined calorimetric system as a color gamut corresponding to the specific image in accordance with the determination result by the state determination unit, a pixel extraction unit extracting pixels, the color of which belongs to a color gamut after the change by the color gamut change unit, from among pixels in the area detected by the specific image detection unit, and a representative color calculation unit calculating a representative color of the specific image on the basis of the pixels extracted by the pixel extraction unit.

The present application claims the priority based on a Japanese Patent Application No. 2008-161389 filed on Jun. 20, 2008, the disclosure of which is hereby incorporated by reference in its entirety.

### BACKGROUND

1. Technical Field

The present invention relates to an image processing apparatus, an image processing method, and an image processing program.

2. Related Art

In the field of an image processing, there is an attempt to correct the color of a face image in an input image obtained from a digital still camera or the like to an ideal flesh color. When such correction is performed, a printer or the like that executes an image processing finds a color (appropriately called a skin representative color) representing a skin portion of the face image in the input image before correction, and performs correction for each pixel of the input image by a correction amount based on the found skin representative color. As such a technology, an image processing apparatus is known which specifies a face area from a target image and uses, as a flesh color representative value FV, RGB values calculated by averaging the pixel values (RGB) of all pixels in the face area for the R, G, and B values (see JP-A-2006-261879).

In order to appropriately perform the above-described correction, it is necessary to obtain a skin representative color, in which the color of the skin portion of the face image in the input image before correction is accurately reflected. [0004]In the related art, a method is used which detects a rectangular area including the face image on the input image and calculates a skin representative color on the basis of the color of each pixel in the detected rectangular area. However, the rectangular area may include pixels outside the face contour or pixels not corresponding to the skin portion in the face (pixels corresponding to hair, eyes, eyebrows, or lips). For this reason, it could not necessarily be said that the skin representative color, which is calculated on the basis of the color of each pixel in the rectangular area as described above, accurately reflects the color of the skin portion of the face image.

A method is also used which defines a color gamut (flesh color gamut) including a standard flesh color in a predetermined calorimetric system in advance, extracts pixels belonging to the flesh color gamut from among the pixels in the input image, and finds a skin representative color on the basis of the color of each extracted pixel. However, since the input image that is arbitrarily selected by the user may be overall dark or bright, or in a color seepage state, the color of the skin portion of the face image in the input image may be out of the flesh color gamut. When the color of the skin portion of the face image is out of the flesh color gamut, each pixel constituting the skin portion of the face image may not be used in calculating the skin representative color, and as a result, an accurate skin representative color may not be calculated.

### SUMMARY

An advantage of some aspects of the invention is that it provides an image processing apparatus, an image processing method, and an image processing program capable of obtaining information accurately reflecting the color of a specific image in an input image subject to an image processing.

According to an aspect of the invention, an image processing apparatus includes a specific image detection unit detecting an area including at least a part of a specific image in an input image, a state determination unit determining the state of the input image, a color gamut change unit changing a prescribed color gamut in a predetermined calorimetric system as a color gamut corresponding to the specific image in accordance with the determination result by the state determination unit, a pixel extraction unit extracting pixels, the color of which belongs to a color gamut after the change by the color gamut change unit, from among pixels in the area detected by the specific image detection unit, and a representative color calculation unit calculating a representative color of the specific image on the basis of the pixels extracted by the pixel extraction unit.

According to this aspect of the invention, the prescribed color gamut in the predetermined calorimetric system is changed in accordance with the state of the input image. The representative color of the specific image is calculated on the basis of the pixels, which are in the area in the specific image detected from the input image and the color of which belongs to the color gamut after the change. For this reason, the representative color accurately reflecting the color of the specific image in the input image can be obtained, regardless of the state of the input image.

The state determination unit may acquire a predetermined feature value from the input image and may determine, on the basis of the feature value, whether or not the input image is a color seepage image, and when the state determination unit determines that the input image is a color seepage image, the color gamut change unit may at least move and/or deform the prescribed color gamut such that a hue range is changed. With this configuration, even though the input image is in a color seepage state, if the prescribed color gamut is moved and/or deformed such that the hue range is changed, the pixels suitable for calculation of the representative color can be accurately extracted.

The state determination unit may acquire a predetermined feature value from the input image and may determine, on the basis of the feature value, whether or not the input image is an under image, and when the state determination unit determines that the input image is an under image, the color gamut change unit may at least move and/or deform the prescribed color gamut so as to include a color gamut on a low chroma side, as compared with the color gamut before the change. With this configuration, even though the input image is an exposure-shortage so-called under image (overall dark image), if the prescribed color gamut is moved and/or deformed so as to include the color gamut on the low chroma side, as compared with the color gamut before the change, the pixels suitable for calculation of the representative color can be accurately extracted.

The representative color calculation unit may calculate the average value for every element color in each pixel extracted by the pixel extraction unit and may set the color formed by the calculated average value for every element color as the representative color. With this configuration, the representative color accurately representing the feature of the color of the specific image can be obtained.

The pixel extraction unit may detect the contour of the specific image within the area detected by the specific image detection unit and may extract pixels, the color of which belongs to the color gamut after the change, from among pixels in the detected contour. With this configuration, only the pixels, which satisfy the positional conditions that there are within the detected area and contour, and the color of which belongs to the color gamut after the change, are extracted. For this reason, the representative color can be calculated while pixels unnecessary for calculation of the representative color are excluded as much as possible.

The specific image detection unit may detect an area including at least a part of a face image in the input image, and the color gamut change unit may change a prescribed flesh color gamut in a predetermined calorimetric system. With this configuration, even though the color of the face in the input image varies from a standard flesh color, the representative color accurately reflecting the color of the face can be obtained.

In addition to the above-described image processing apparatus, the technical idea of the invention may be applied to an image processing method that includes processing steps executed by the units of the image processing apparatus, and an image processing program that causes a computer to execute functions corresponding to the units of the image processing apparatus. The image processing apparatus, the image processing method, and the image processing program may be implemented by hardware, such as a PC or a server, and it may also be implemented by various products, such as a digital still camera or a scanner as an image input apparatus, a printer, a projector, or a photo viewer as an image output apparatus, and the like.

### BRIEF DESCRIPTION OF THE DRAWINGS

The invention will be described with reference to the accompanying drawings, wherein like numbers reference like elements.

FIG. 1 is a block diagram showing the schematic configuration of a printer.

FIG. 2 is a flowchart showing a skin representative color acquisition processing that is executed by a printer.

FIG. 3 is a diagram showing a face area detected in image data.

FIGS. 4A to 4C are diagrams showing histograms for element colors.

FIG. 5 is a diagram showing an example where an area of image data is divided into a central area and a peripheral area.

FIG. 6 is a diagram showing a flesh color gamut that is defined by flesh color gamut definition information.

FIG. 7 is a diagram showing an example of a change of a flesh color gamut.

FIG. 8 is a diagram showing an example of a change of a flesh color gamut.

FIG. 9 is a diagram showing an example of a change of a flesh color gamut.

### DESCRIPTION OF EXEMPLARY EMBODIMENTS

Hereinafter, an embodiment of the invention will be described with reference to the drawings.

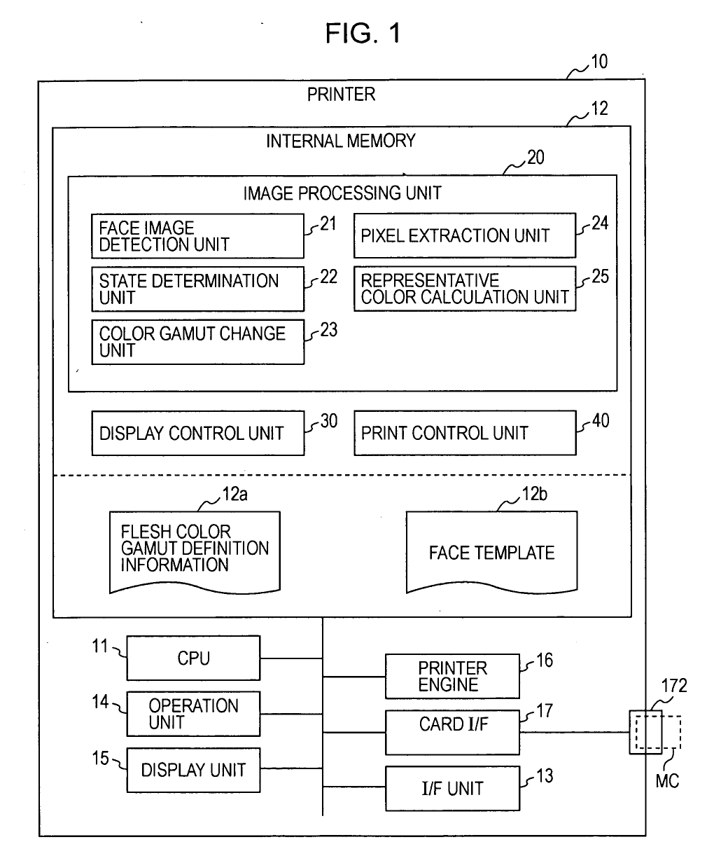

FIG. 1 schematically shows the configuration of a printer 10 which is an example of an image processing apparatus of the invention. The printer 10 is a color printer (for example, a color ink jet printer) that prints an image on the basis of image data acquired from a recording medium (for example, a memory card MC or the like), that is, addresses so-called direct print. The printer 10 includes a CPU 11 controlling the individual units of the printer 10, an internal memory 12 formed by, for example, an ROM or a RAM, an operation unit 14 formed by, for example, buttons or a touch panel, a display unit 15 formed by a liquid crystal display, a printer engine 16, a card interface (card I/F) 17, and an I/F unit 13 for exchange of information with various external apparatuses, such as a PC, a server, a digital still camera, and the like. The constituent elements of the printer 10 are connected to each other through a bus.

The printer engine 16 is a print mechanism for printing on the basis of print data. The card I/F 17 is an I/F for exchange of data with a memory card MC inserted into a card slot 172. The memory card MC stores image data, and the printer 10 can acquire image data stored in the memory card MC through the card I/F 17. As the recording medium for provision of image data, various mediums other than the memory card MC may be used. Of course, the printer 10 may acquire image data from the external apparatus, which is connected thereto through the I/F unit 13, other than the recording medium. The printer 10 may be a consumer-oriented printing apparatus or a DPE-oriented printing apparatus for business use (so-called mini-lab machine). The printer 10 may acquire print data from the PC or the server, which is connected thereto through the I/F unit 13.

The internal memory 12 stores an image processing unit 20, a display control unit 30, and a print control unit 40. The image processing unit 20 is a computer program that executes various kinds of image processing, including a skin representative color acquisition processing (described below), for image data under a predetermined operating system. The display control unit 30 is a display driver that controls the display unit 15 to display a predetermined user interface (UI) image, a message, or a thumbnail image on the screen of the display unit 15. The print control unit 40 is a computer program that generates print data defining the amount of a recording material (ink or toner) to be recorded in each pixel on the basis of image data, which is subjected to image processing, and controls the printer engine 16 to print an image onto a print medium on the basis of print data.

The CPU 11 reads out each program from the internal memory 12 and executes the program to implement the function of each unit. The image processing unit 20 further includes, as a program module, at least a face image detection unit 21, a state determination unit 22, a color gamut change unit 23, a pixel extraction unit 24, and a representative color calculation unit 25. The face image detection unit 21 corresponds to a specific image detection unit. The functions of these units will be described below. The internal memory 12 stores various kinds of data, such as flesh color gamut definition information 12a , face template 12b , and the like, or programs. The printer 10 may be a so-called multi-function device including various functions, such as a copy function or a scanner function (image reading function), in addition to a print function.

Next, a skin representative color acquisition processing that is executed by the image processing unit 20 in the printer 10 will be described. The skin representative color means a color representing a face image in an input image, and more specifically, means a color representing a color of a skin portion of the face image.

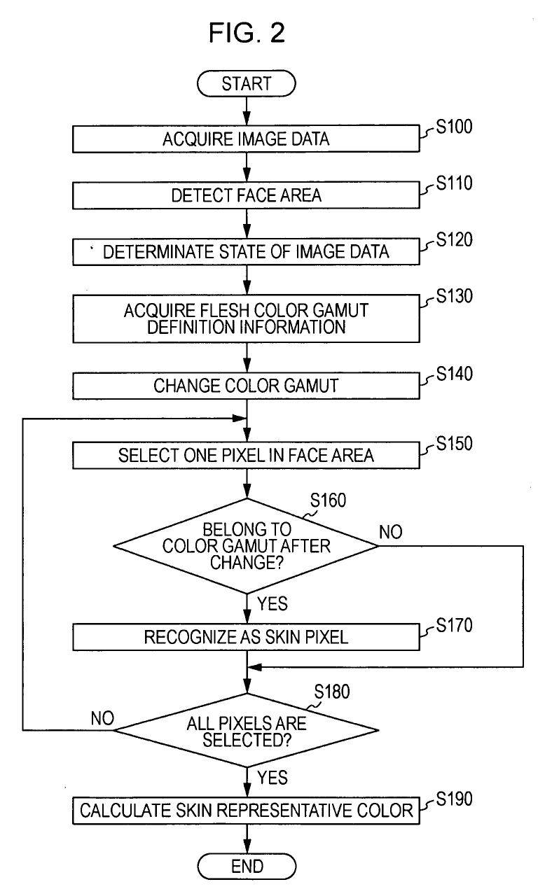

FIG. 2 is a flowchart illustrating a skin representative color acquisition processing.

In Step S100 (hereinafter, “Step” will be omitted), the image processing unit 20 acquires image data D representing an image to be processed from a recording medium, such as the memory card MC or the like. That is, when a user operates the operation unit 14 in reference to a UI image displayed on the display unit 15 and assigns image data D to be processed, the image processing unit 20 reads assigned image data D. The image processing unit 20 may acquire image data D from the PC, the server, the digital still camera, or the like through the I/F unit 13. Image data D is bitmap data in which the color of each pixel is expressed by gradation values for every element color (RGB). Image data D may be compressed when being recorded in the recording medium, or the color of each pixel may be expressed by a different colorimetric system. In these cases, development of image data D or conversion of the calorimetric system is executed, and the image processing unit 20 acquires image data D as RGB bitmap data. The so-acquired image data D corresponds to an input image.

In S110, the face image detection unit 21 detects a face area from image data D. The face area means an area that includes at least a part of the face image. With respect to the face image detection unit 21, any method may be used insofar as the face area can be detected. For example, the face image detection unit 21 detects the face area from image data D by so-called pattern matching using a plurality of templates (the above-described face template 12b ). In the pattern matching, a rectangular detection area SA is set on image data D, and similarity between an image within the detection area SA and an image of each face template 12b is evaluated while changing the position and size of the detection area SA on image data D. A detection area SA that has similarity satisfying a predetermined reference is specified (detected) as a face area. The face area may be detected for a single face or multiple faces within image data D by moving the detection area SA over the entire image data D. In this embodiment, a description will be provided for an example where a single face area including a single face is detected. The face image detection unit 21 may detect a face area by using a preliminarily learned neural network which receives various kinds of information of an image (for example, luminance information, edge amount, contrast, or the like) in the unit of the detection area SA and outputs information on whether or not a face image is present in the detection area SA, or may determine, by using a support vector machine, whether or not a face area is present in each detection area SA.

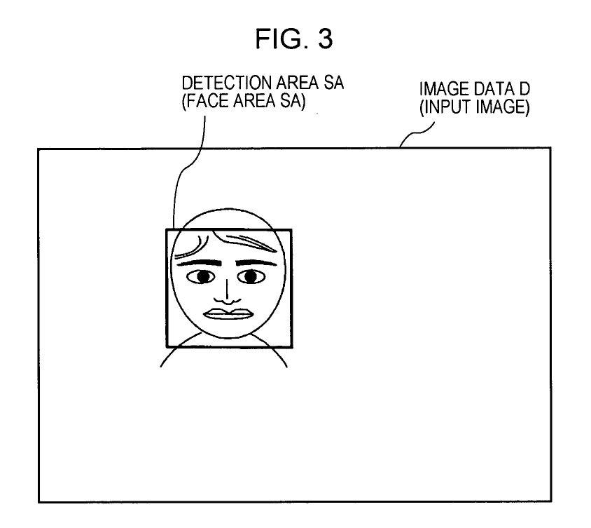

FIG. 3 shows a rectangular detection area SA detected from image data D as a face area in S110. Hereinafter, the detection area SA that is detected as the face area in S110 is called a face area SA.

In S120, the state determination unit 22 determines the state of image data D. The state of image data D means a state that is decided on the basis of color balance or brightness in the image of image data D, the feature of a subject in the image, or the like. In this embodiment, in S120, determination on whether or not image data D is a color seepage image and determination on whether or not image data D is an under image are carried out by a predetermined determination method.

The state determination unit 22 carries out determination on whether or not image data D is a color seepage image, for example, as follows. The state determination unit 22 first samples pixels with a predetermined extraction ratio for the entire range of image data D and generates a frequency distribution (histogram) for every RGB in the sampled pixels. Then, the state determination unit 22 calculates feature values in the R, G, and B histograms, for example, maximum values (average values, medians, or maximum distribution values may be used) Rmax, Gmax, and Bmax, and determines, on the basis of the magnitude relationship between the feature values, whether or not image data D is a color seepage image.

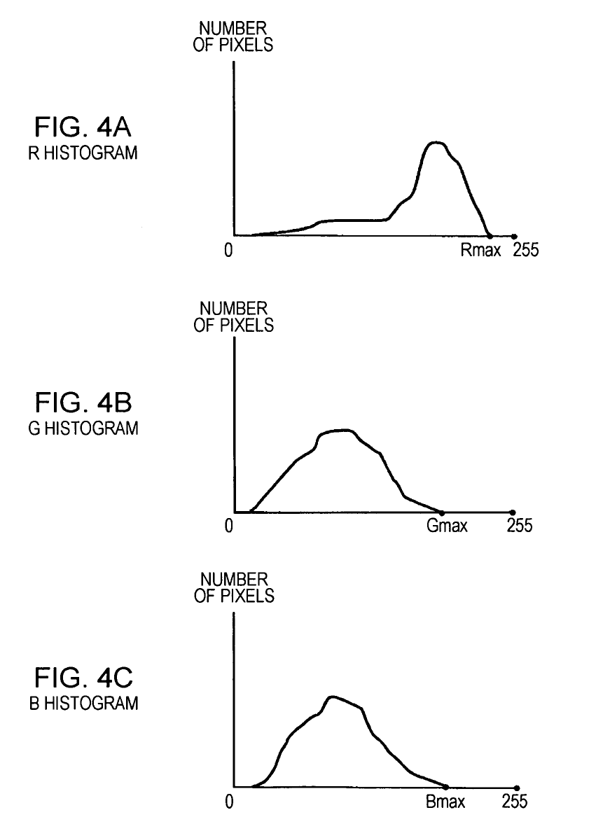

FIGS. 4A, 4B, and 4C illustrate histograms for RGB generated by the state determination unit 22. In the histograms shown in FIGS. 4A to 4C, the horizontal axis represents a gradation value (0 to 255) and the vertical axis represents the number of pixels (frequency). For example, if |Rmax-Gmax| and |Rmax-Bmax| from among |Rmax-Gmax|, |Rmax-Bmax|, and |Bmax-Gmax| differences between the maximum values Rmax, Gmax, and Bmax are larger than |Bmax-Gmax| by a predetermined value, and the conditions Rmax>Gmax and Rmax>Bmax are satisfied, the state determination unit 22 determines that the image of image data D is in a red seepage state or an orange seepage state (a state where the image is overall reddish, a kind of color seepage). Alternatively, the state determination unit 22 may sample pixels from the face area SA, may calculate the average values Rave, Gave, and Bave for RGB in the sampled pixels, and may determine, on the basis of the magnitude relationship between the average values Rave, Gave, and Bave, whether or not image data D is a color seepage image. That is, since many pixels in the face area SA are pixels corresponding to the skin portion of the face image, if the balance between the average values Rave, Gave, and Bave calculated from the pixels in the face area SA is determined by the above-described determination method, it is determined whether or not the face in the input image is a color seepage state. This determination result is set as a determination result regarding the state of the input image.

The state determination unit 22 carries out determination on whether or not image data D is an under image, for example, as follows. As described above, when the pixels are sampled with a predetermined extraction ratio for the entire range of image data D, the state determination unit 22 finds the average value of luminance (luminance average value) of the sampled pixels. The luminance average value is one of the feature values of image data D. Next, the state determination unit 22 compares the luminance average value with a predetermined threshold value, and when the luminance average value is equal to or less than the threshold value, determines that image data D is an overall dark image, that is, an under image. The threshold value used herein is data that is calculated in advance and stored in the internal memory 12 of the printer 10 or the like. In this embodiment, a plurality of different images that are evaluated as an under image are prepared in advance for calculation of the threshold value, the luminance average values of the images for calculation of the threshold value are calculated, and the maximum value from among the calculated luminance average values is stored as the threshold value.

Alternatively, the state determination unit 22 may calculate the luminance average value of image data D while giving different weighted values to the areas of image data D. For example, the state determination unit 22 divides image data D into a central area and a peripheral area. The central area and the peripheral area may be divided in various ways. For example, the state determination unit 22 sets a frame-shaped area along the four sides of the image of image data D as a peripheral area, and sets an area other than the peripheral area as a central area.

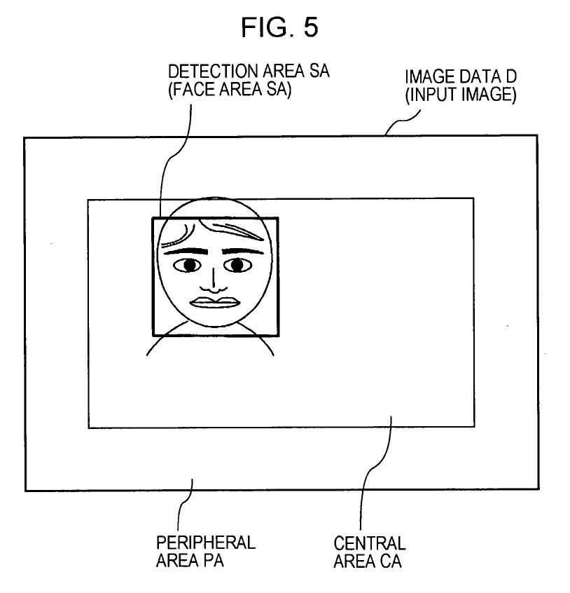

FIG. 5 illustrates an example where the state determination unit 22 divides the image area of image data D into a central area CA and a peripheral area PA.

When sampling the pixels from image data D, the state determination unit 22 samples pixels with an extraction ratio higher in the central area CA than in the peripheral area PA, and calculates the luminance average value for each sampled pixel. In this way, through comparison of the luminance average value calculated with emphasis on the central area CA and the threshold value, while the influence of luminance of the central area CA is strongly reflected, it can be determined whether or not image data D is an under image. That is, even though the peripheral area PA is comparatively bright, if the central area CA where a main subject, such as a face or the like, is likely to be present is comparatively dark, it is liable to be determined that image data D is an under image. For this reason, when image data D is a so-called backlight image in which an image central portion is dark, it is liable to be determined that image data D is an under image.

The determination method on whether or not image data D is a color seepage image and the determination method on whether or not image data D is an under image are not limited to the above-described methods.

In S130, the color gamut change unit 23 reads out the flesh color gamut definition information 12a from the internal memory 12. The flesh color gamut definition information 12a is information with a preliminarily defined standard range (flesh color gamut) of a color (flesh color) corresponding to an image (face image) to be detected by the face image detection unit 21 in a predetermined colorimetric system. In this embodiment, for example, the flesh color gamut definition information 12a defines a flesh color gamut in an L*a*b* calorimetric system (hereinafter, “*” is omitted) defined by the CIE (International Commission on Illumination). With respect to the definition of the flesh color gamut by the flesh color gamut definition information 12a , various calorimetric systems, such as an HSV calorimetric system, an XYZ colorimetric system, a RGB calorimetric system, and the like, may be used. It should suffice that the flesh color gamut definition information 12a is information defining a flesh-like color gamut in a calorimetric system.

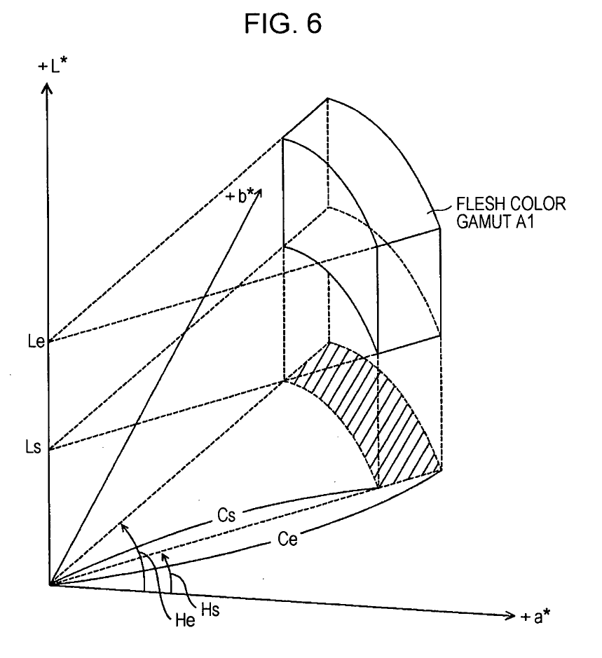

FIG. 6 shows an example of a flesh color gamut A1 that is defined by the flesh color gamut definition information 12a in the Lab calorimetric system. The flesh color gamut definition information 12a defines the flesh color gamut A1 by the ranges of lightness L, chroma C, and hue H, Ls≦L≦Le, Cs≦C≦Ce, and Hs≦H≦He. In the example of FIG. 6, the flesh color gamut A1 is a solid having six faces. FIG. 6 also shows a projection view of the flesh color gamut A1 onto the ab plane by hatching. The flesh color gamut that is defined by the flesh color gamut definition information 12a does not need to be a six-faced solid. For example, the flesh color gamut may be a spherical area that is defined by a single coordinate in the Lab calorimetric system representing the center point of the flesh color gamut and a radius r around the single coordinate, or other shapes may be used.

In S140, the color gamut change unit 23 changes the flesh color gamut A1 in accordance with the determination result by the state determination unit 22. Specifically, when in S120, the state determination unit 22 determines that image data D is a color seepage image, the color gamut change unit 23 at least changes the hue range of the flesh color gamut A1 in accordance with the state of color seepage. When in S120, the state determination unit 22 determines that image data D is an under image, the color gamut change unit 23 changes the flesh color gamut A1 so as to be enlarged to a low chroma side and a high chroma side, as compared with the color gamut before change.

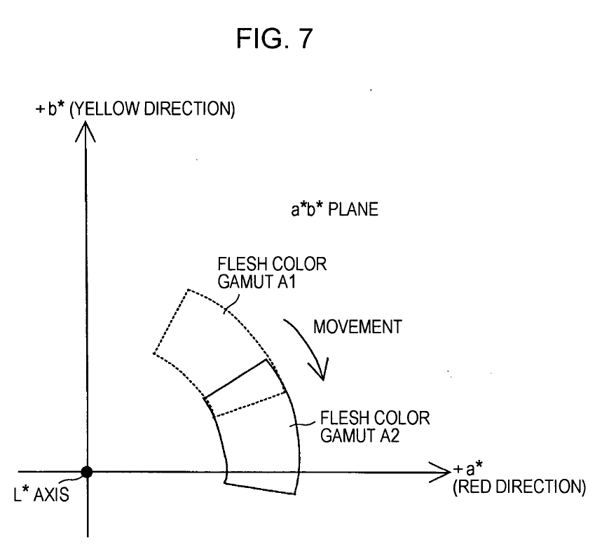

FIG. 7 shows an example of a color gamut change by the color gamut change unit 23 when the state determination unit 22 determines that image data D is an image in a red seepage state. In FIG. 7, a flesh color gamut A1 (chain line) before change and a flesh color gamut A2 (solid line) after change are shown on the ab plane in the Lab colorimetric system. When image data D is an image in a red seepage state, as shown in FIG. 7, the color gamut change unit 23 moves the flesh color gamut A1 in a clockwise direction around an L axis (gray axis) such that the hue range of the flesh color gamut A1 approaches an a axis indicating a red direction (or such that the hue range crosses the a axis). That is, since image data D is an overall reddish image, the color of the skin portion of the face image tends to be reddish. For this reason, a shift between the color of each pixel of the reddish skin portion and the flesh color gamut, which is intrinsically defined by the flesh color gamut definition information 12a , is corrected. Let the hue range after the movement be Hs′≦H≦He′, then, the flesh color gamut A2 is defined by the ranges of lightness L, chroma C, and hue H, Ls≦L≦Le, Cs≦C≦Ce, and Hs′≦H≦He′. It is assumed that hue H in the fourth quadrant (an area where a is positive and b is negative) of the ab plane is expressed by an angle in a clockwise direction from the a axis (0 degree) and has a negative value.

Alternatively, when it is determined that image data D is an image in a red seepage state, the color gamut change unit 23 may deform (enlarge) the flesh color gamut A1 around the L axis such that one end (Hs) of the hue range of the flesh color gamut A1 approaches the a axis (or crosses the a axis), and may set the area after enlargement as the flesh color gamut A2. Let the hue range after enlargement be Hs′≦H≦He, the flesh color gamut A2 is defined by the ranges Ls≦L≦Le, Cs≦C≦Ce, and Hs′≦H≦He.

Alternatively, when it is determined that image data D is a color seepage image, the color gamut change unit 23 may acquire the flesh color gamut A2 after change by moving the hue range of the flesh color gamut A1 while enlarging.

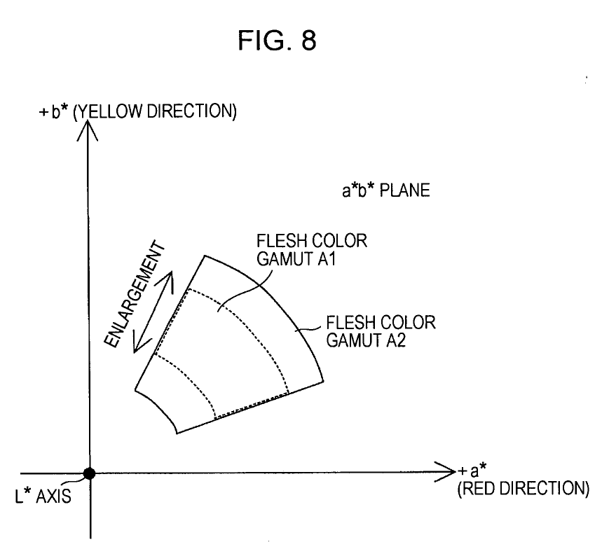

FIG. 8 illustrates an example of a color gamut change by the color gamut change unit 23 when the state determination unit 22 determines that image data D is an under image. In FIG. 8, similarly to FIG. 7, the flesh color gamut A1 (chain line) before change and the flesh color gamut A2 (solid line) after change are shown on the ab plane. When image data D is an under image, the color gamut change unit 23 enlarges the chroma range of the flesh color gamut A1 to the low chroma side (L-axis side) and the high chroma side, and sets a color gamut after enlargement as the flesh color gamut A2. The chroma for every pixel (referred to as chroma S) may be expressed by the following expression using RGB for every pixel.

Chroma S={(max−min)/max}·100 (1)

Meanwhile, it is assumed that max=max(R,G,B) and min=min(R,G,B). In the case of an under image, since the value max tends to be low, the value max-min has a strong influence on decision of chroma S, and chroma S increases or decreases in accordance with the value max-min (chroma is unstable). That is, when image data D is an under image, it is supposed that the chroma of each pixel of the skin portion of the face image is unstable. Accordingly, in this embodiment, the flesh color gamut that is intrinsically defined by the flesh color gamut definition information 12a is enlarged to the low chroma side and the high chroma side, thereby covering the unstableness. Let the chroma range after enlargement be Cs′≦C≦Ce′, then, the flesh color gamut A2 is defined by the ranges of lightness L, chroma C, and hue H, Ls≦L≦Le, Cs′≦C≦Ce′, and Hs≦H≦He.

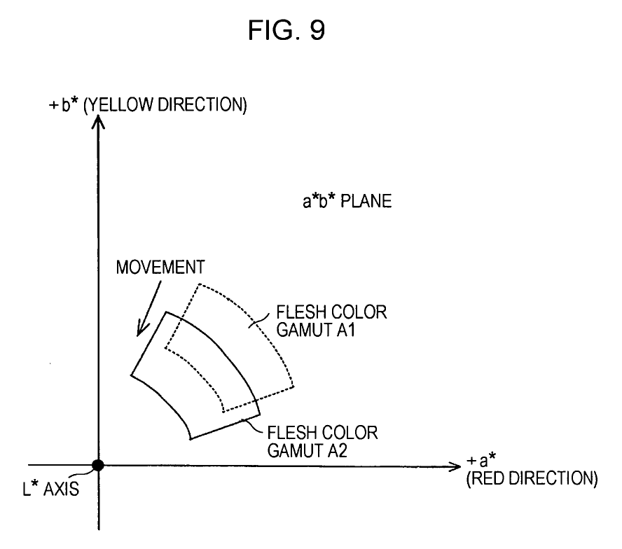

Meanwhile, from a viewpoint that when it is determined that image data D is an under image, the flesh color gamut A1 is changed so as to include at least a color gamut on the low chroma side, as compared with the color gamut before change, as shown in FIG. 9, the color gamut change unit 23 may move the entire flesh color gamut A1 to the low chroma side (a flesh color gamut after movement is set as the flesh color gamut A2), or may enlarge the flesh color gamut A1 only to the low chroma side. When the flesh color gamut A1 is enlarged to the low chroma side, the color gamut change unit 23 may deform (enlarge) the flesh color gamut A1 to the L-axis side such that the lower limit (Cs) of the chroma range of the flesh color gamut A1 approaches to the L axis, and may set a color gamut after enlargement as the flesh color gamut A2. Let the chroma range after enlargement be Cs′ C Ce, the flesh color gamut A2 is defined by the ranges Ls L Le, Cs′ C Ce, and Hs H He.

Alternatively, when it is determined that image data D is an under image, the color gamut change unit 23 may acquire the flesh color gamut A2 after change by moving the chroma range of the flesh color gamut A1 while enlarging.

When it is determined that image data D is a color seepage image and an under image, the color gamut change unit 23 changes the hue range and the chroma range of the flesh color gamut A1 in the above-described manner. The color gamut change unit 23 may change the lightness range of the flesh color gamut A1 in accordance with the determination result of the state of image data D in S120. When it is not determined in S120 that image data D is a color seepage image or an under image, in S140, the color gamut change unit 23 does not carry out a color gamut change.

In this embodiment, a description will be provided for an example where a color gamut change is carried out in S140.

In S150, the pixel extraction unit 24 selects one pixel from among the pixels, which are in image data D and belong to the face area SA, and the processing progresses to S160.

In S160, the pixel extraction unit 24 determines whether or not the color of the pixel selected in previous S150 belongs to the flesh color gamut A2 after the color gamut change. In this case, the pixel extraction unit 24 converts RGB data of the selected pixel into data (Lab data) of the calorimetric system (Lab calorimetric system) used by the flesh color gamut A2, and determines whether or not Lab data after conversion belongs to the flesh color gamut A2. When the pixel extraction unit 24 determines that Lab data belongs to the flesh color gamut A2, the processing progresses to S170. When it is determined that Lab data does not belong to the flesh color gamut A2, the processing skips S170 and progresses to S180. The pixel extraction unit 24 may convert RGB data into Lab data by using a predetermined color conversion profile for conversion from the RGB colorimetric system into the Lab colorimetric system or the like. The internal memory 12 may also store such a color conversion profile.

In S170, the pixel extraction unit 24 recognizes the pixel selected in previous S150 as a skin pixel. As a result, pixels, the color of which belongs to the flesh color gamut A2 after change, from among the pixels in the area detected by the face image detection unit 21 are extracted. It can be said that the so-extracted skin pixels are basically pixels corresponding to the skin portion of the face image in image data D. Although the color of each skin pixel is not limited to a color that belongs to the color gamut intrinsically defined by the flesh color gamut definition information 12a , the skin pixels should be expressed by an ideal flesh color.

In S180, the pixel extraction unit 24 determines whether or not all the pixels belonging to the face area SA are selected once in S150, and if all the pixels are selected, the processing progresses to S190. When there are pixels, which are not selected in S150, from among the pixels belonging to the face area SA, the processing returns to S150, one of the unselected pixels is selected, and S160 and later are repeated. In this embodiment, a case where a single face area SA is detected from the image data D has been described. Meanwhile, when a plurality of face areas SA are detected from image data D, in S150 to S180, for each pixel in a plurality of face areas SA, the pixel extraction unit 24 determines whether or not the color belongs to the flesh color gamut A2, and recognizes pixels, the color of which belongs to the flesh color gamut A2, as skin pixels.

In S190, the representative color calculation unit 25 calculates the skin representative color on the basis of a plurality of skin pixels recognized (extracted) in S170. The skin representative color may be calculated in various ways. In this embodiment, the representative color calculation unit 25 calculates the average values Rave, Gave, and Bave for RGB in the skin pixels, and sets, as the skin representative color, a color (RGB data) formed by the calculated average values Rave, Gave, and Bave for RGB in the skin pixels. The representative color calculation unit 25 stores RGB data of the skin representative color in a predetermined memory area, such as the internal memory 12 or the like, and ends the flowchart of FIG. 2.

The image processing unit 20 may use the skin representative color calculated in the above-described manner in various kinds of image processing. For example, the image processing unit 20 may generate a correction function (for example, a tone curve) for every RGB in accordance with a difference between RGB data of the skin representative color and RGB data representing a prescribed ideal flesh color for every RGB, and may correct RGB of the pixels of image data D by using such a correction function.

As described above, according to this embodiment, the printer 10 detects the face area from the input image, analyzes the input image to determine whether or not the input image is a color seepage image or an under image, changes the flesh color gamut A1 defined by the flesh color gamut definition information 12a in accordance with the determination result, and generates the flesh color gamut A2 after change. The printer 10 extracts the pixels, the color of which belongs to the flesh color gamut A2, from among the pixels belonging to the face area, and averages the colors of the extracted pixels to acquire the skin representative color of the face image in the input image. That is, the flesh color gamut that is referred to when the pixels for calculation of the skin representative color are extracted from the face area is changed in accordance with the state of the input image. Therefore, even if the color balance is broken and the input image is, for example, an overall reddish image or an overall dark image, the shift between the color of the skin portion of the face and the flesh color gamut is eliminated. As a result, the pixels corresponding to the skin portion of the face in the input image can be reliably extracted, regardless of the state of the input image, and an accurate skin representative color can be obtained for every input image. With such a skin representative color, optimum correction can be carried out for the input image.

In addition to or instead of the above description, in this embodiment, the following modifications may be made.

For example, in S120, the state determination unit 22 may determine, on the basis of the feature value (for example, the luminance average value) of image data D, whether or not image data D is an exposure-excess over image (overall bright image). When the state determination unit 22 determines that image data D is an over image, the color gamut change unit 23 may change the flesh color gamut A1 so as to include a color gamut on the low chroma side, as compared with the color gamut before change. In the case of an over image, the value max-min in Equation (1) tends to be small, and the value max tends to be high. Accordingly, the chroma of each pixel is low as a whole. Therefore, when image data D is an over image, with movement or enlargement of the flesh color gamut A1 to the low chroma side, even if image data D tends to be excessively exposed, the skin representative color can be accurately acquired.

The state determination unit 22 may analyze the face image in the face area SA to determine a human race (oriental race, white, black, or the like). As the determination method of the human race of the face image, a known method may be used. The color gamut change unit 23 changes the flesh color gamut A1 in accordance with the human race determined by the state determination unit 22. For example, the state determination unit 22 enlarges the chroma range of the flesh color gamut A1 in accordance with the determined human race while keeping the range intrinsically defined by the flesh color gamut A1. With this configuration, the representative color representing the color of the skin of the face can be accurately acquired, regardless of the difference in the human race of the face caught in the input image.

The pixel extraction unit 24 may detect the contour of the face image in the face area SA. The contour of the face image is the contour that is formed by the line of the chin or the line of the cheek. The pixel extraction unit 24 detects, for example, an edge within a predetermined range outside the facial organs, such as eyes, a nose, and a mouth, in the face area SA, thereby detecting the contour of the face image. The pixel extraction unit 24 specifies the inside and outside of the contour on the basis of the shape of the detected contour. In S150, the pixel extraction unit 24 selects only pixels, which are present inside the contour, from among the pixels belonging to the face area SA, and in S160, determines whether or not the color of each pixel selected in S150 belongs to the flesh color gamut A2 after change. That is, if the pixels in the rectangular face area SA are selected in S150, the pixels that are present in the face area SA and outside the contour of the face may also be extracted as skin pixels depending on the color. As described above, if the pixels to be selected in S150 are limited by the contour, only the pixels corresponding to the skin portion of the face image can be extracted as the skin pixels, and as a result, an accurate skin representative color can be obtained.

Although in this embodiment, a case where the specific image is a face image has been described, a specific image that can be detected by the configuration of the invention is not limited to a face image. That is, in the invention, various objects, such as artifacts, living things, natural things, landscapes, and the like, can be detected as the specific image. The representative color to be calculated is a color representing a specific image as an object to be detected.

What is claimed is:

1. An image processing apparatus comprising:
a specific image detection unit detecting an area including at least a part of a specific image in an input image;
a state determination unit determining the state of the input image;
a color gamut change unit changing a prescribed color gamut in a predetermined colorimetric system as a color gamut corresponding to the specific image in accordance with the determination result by the state determination unit;
a pixel extraction unit extracting pixels, the color of which belongs to a color gamut after the change by the color gamut change unit, from among pixels in the area detected by the specific image detection unit; and
a representative color calculation unit calculating a representative color of the specific image on the basis of the pixels extracted by the pixel extraction unit.

2. The image processing apparatus according to claim 1,
wherein the state determination unit acquires a predetermined feature value from the input image and determines, on the basis of the feature value, whether or not the input image is a color seepage image, and when the state determination unit determines that the input image is a color seepage image, the color gamut change unit at least moves and/or deforms the prescribed color gamut such that a hue range is changed.

3. The image processing apparatus according to claim 1,
wherein the state determination unit acquires a predetermined feature value from the input image and determines, on the basis of the feature value, whether or not the input image is an under image, and when the state determination unit determines that the input image is an under image, the color gamut change unit at least moves and/or deforms the prescribed color gamut so as to include a color gamut on a low chroma side, as compared with the color gamut before the change.

4. The image processing apparatus according to claim 1,
wherein the representative color calculation unit calculates the average value for every element color in each pixel extracted by the pixel extraction unit and sets the color formed by the calculated average value for every element color as the representative color.

5. The image processing apparatus according to claim 1,
wherein the pixel extraction unit detects the contour of the specific image within the area detected by the specific image detection unit and extracts pixels, the color of which belongs to the color gamut after the change, from among pixels in the detected contour.

6. The image processing apparatus according to claim 1,
wherein the specific image detection unit detects an area including at least a part of a face image in the input image, and the color gamut change unit changes a prescribed flesh color gamut in a predetermined colorimetric system.

7. An image processing method comprising using a processor to perform the operation:
detecting an area including at least a part of a specific image in an input image;
determining the state of the input image;
changing a prescribed color gamut in a predetermined calorimetric system as a color gamut corresponding to the specific image in accordance with the determination result in the determining of the state;
extracting pixels, the color of which belongs to a color gamut after the change by the changing of the color gamut, from among pixels in the area detected in the detecting of the specific image; and
calculating a representative color of the specific image on the basis of the pixels extracted in the extracting of the pixels.

8. A computer program product comprising:
a computer-readable storage medium; and
a computer program stores on the computer-readable storage medium, the computer program including;
a first program for causing a computer to detect an area including at least a part of a specific image in an input image;
a second program for causing a computer to determine the state of the input image;
a third program for causing a computer to change a prescribed color gamut in a predetermined calorimetric system as a color gamut corresponding to the specific image in accordance with the determination result in the determining of the state;
a forth program for causing a computer to extract pixels, the color of which belongs to a color gamut after the change by the changing of the color gamut, from among pixels in the area detected in the detecting of the specific image; and
a fifth program for causing a computer to calculate a representative color of the specific image on the basis of the pixels extracted in the extracting of the pixels.
